(19) United States
(12) Patent Application Publication
(10) Pub. No.: US 2026/0340104 A1
(43) Pub. Date: Oct. 29, 2026

(54) SYSTEMS AND METHODS FOR A GENERATIVE ARTIFICIAL INTELLIGENCE MODULE UNLOCK

(71) Applicant: The Toronto-Dominion Bank, Toronto (CA)

(72) Inventors: Vithusan THAVARAJAH, Markham (CA); Anthony Haituyen NGUYEN, Toronto (CA)

(73) Assignee: The Toronto-Dominion Bank, Toronto (CA)

(21) Appl. No.: 19/189,998

(22) Filed: Apr. 25, 2025

(51) Int. Cl. G06F 21/44; H04L 9/40; H04L 41/16

(52) U.S. Cl. CPC G06F 21/44; H04L 41/16; H04L 63/308

(57) ABSTRACT

The present application relates to systems and methods for real-time analyzing of operational feature-unlock for a real-time interactive exchange. A server receives the interactive exchange from a remote-computing system. A generative artificial intelligence model evaluates a programmatic adherence of the interactive exchange to a machine-rule set. Responsive to an inference output from the generative artificial intelligence model indicating the programmatic adherence of the interactive exchange to the machine-rule set, the server signals the remote-computing system to enable one or more computer-modules on the remote-computing system.

### TECHNICAL FIELD

The present application relates to the field of artificial intelligence and machine learning. More specifically, the present application relates to systems and methods for unlocking modules based on a real-time analyzing of execution flow integrity.

### BACKGROUND

Lockout systems using computers may prevent accidental machine startups. These systems, often part of a lockout procedure, ensure that equipment is properly shut down and/or de-energized. Computerized lockout systems can control access to machinery by requiring digital authorization, such as a login, before reactivation. Lockout systems can integrate with other safety protocols, such as biometric verification or RFID tags, to enhance security. Additionally, these systems can log all lockout activities, providing a detailed record for compliance and safety audits. This approach minimizes human error and ensures a higher level of safety for workers.

### BRIEF DESCRIPTION OF THE DRAWINGS

Embodiments are described in detail below, with reference to the following drawings:

FIG. 1 is a schematic operation diagram illustrating an operating environment;

FIG. 2 is a block diagram of a remote-computing system;

FIG. 3 is a block diagram of a resource server;

FIG. 4 is a high-level software architecture executing on a computing device;

FIG. 5 is a block diagram on a parallel processing architecture;

FIG. 6 is a block diagram of a training system for the parallel processing architecture;

FIG. 7 is a flowchart demonstrating a programmatic unlock method;

FIG. 8 is a flowchart demonstrating a programmatic unlock method operating in conjunction with a parallel computing server; and

FIG. 9 is a flowchart demonstrating programmatic unlock method operating in conjunction with a supervisor-computing system.

Like reference numerals are used in the drawings to denote like elements and features.

### DETAILED DESCRIPTION

According to an aspect, there is provided a server comprising: a communications module; at least one processor coupled to the communications module; and a memory coupled to the at least one processor. The memory storing a plurality of processor-executable instructions which, when executed, configure the at least one processor to: receive, from a remote-computing system and via the communications module, an interactive exchange, the interactive exchange being in progress; process the interactive exchange with a generative artificial intelligence model configured to evaluate a programmatic adherence of the interactive exchange to a machine-rule set; and/or responsive to an inference output from the generative artificial intelligence model indicating the programmatic adherence of the interactive exchange to the machine-rule set, signal the remote-computing system via the communications module to enable at least one module on the remote-computing system. The generative artificial intelligence model may be trained with an operational protocol defining the machine-rule set.

When enabling the at least one module on the remote-computing system, the processor-executable instructions, when executed, may further configure the at least one processor to: cause the remote-computing system to indicate by way of a selectable element that the at least one module is enabled.

When signalling the remote-computing system, the processor-executable instructions, when executed, may further configure the at least one processor to: send an application programming interface request to the remote-computing system to cause the at least one module to be enabled.

According to another aspect, the server may further comprise an audio-capture system capturing audio data of the interactive exchange and the processor-executable instructions, when executed, may further configure the at least one processor to: engage a speech-to-text transcription pipeline to transform the audio data into a structured text-based transcript of the interactive exchange for evaluation by the generative artificial intelligence model.

The processor-executable instructions, when executed, may further configure the at least one processor to: receive at least one feature-unlocking recommendation from the generative artificial intelligence model; transmit the at least one feature-unlocking recommendation to the remote-computing system for presentation; and/or monitor the interactive exchange to determine when the at least one feature-unlocking recommendation is satisfied. The at least one feature-unlocking recommendation may include a reference to at least a portion of an operational protocol.

The processor-executable instructions, when executed, may further configure the at least one processor to: receive a feature-unlock score from the generative artificial intelligence model for the interactive exchange; compare the feature-unlock score with a predefined operational threshold; and/or transmit a notification to a supervisor-computing system responsive to the feature-unlock score failing to meet the predefined operational threshold. The processor-executable instructions, when executed, may further configure the at least one processor to: store a plurality of the feature-unlock score and the interactive exchange into a logical storage, the logical storage accessible to the supervisor-computing system; receiving a selection of one of the plurality of the interactive exchange from the supervisor-computing system; and/or responsive to the selection, provide a selected interactive exchange and a selected feature-unlock score to a training database for the generative artificial intelligence model.

The processor-executable instructions, when executed, may further configure the at least one processor to: transmit historical data from a logical storage to the generative artificial intelligence model with a computational instruction to compute a risk score; receive the risk score and compare the risk score to a predefined operational threshold; and/or responsive to the risk score meeting the predefined operational threshold, signal the remote-computing system to enable the at least one module on the remote-computing system.

The processor-executable instructions, when executed, may further configure the at least one processor to: identify an intended action from the interactive exchange; identify an operational protocol associated with the intended action; and/or transmit the operational protocol along with the interactive exchange to the generative artificial intelligence model configured to evaluate the programmatic adherence of the interactive exchange to the machine-rule set, the generative artificial intelligence model generating the machine-rule set from the operational protocol.

According to yet another aspect, there is provided a computer-implemented method comprising: receiving, from a remote-computing system and via a communications module, an interactive exchange, the interactive exchange being in progress; transmitting the interactive exchange to a generative artificial intelligence model configured to evaluate a programmatic adherence of the interactive exchange to a machine-rule set; and/or responsive to an inference output from the generative artificial intelligence model indicating the programmatic adherence of the interactive exchange to the machine-rule set, signalling the remote-computing system via the communications module to enable at least one module on the remote-computing system. The computer-implemented method may further comprise training the generative artificial intelligence model with an operational protocol defining the machine-rule set.

When enabling the at least one module on the remote-computing system, the computer-implemented method may further comprise: causing the remote-computing system to indicate by way of a selectable element that the at least one module is enabled.

The computer-implemented method may further comprise: receiving at least one feature-unlocking recommendation from the generative artificial intelligence model; transmitting the at least one feature-unlocking recommendation to the remote-computing system for presentation; and/or monitoring the interactive exchange to determine when the at least one feature-unlocking recommendation is satisfied.

The computer-implemented method may further comprise: receiving a feature-unlock score from the generative artificial intelligence model for the interactive exchange; comparing the feature-unlock score with a predefined operational threshold; providing the feature-unlock score to a logical storage associated with an operator; and/or determining a recommended disciplinary process responsive to the feature-unlock score being deficient. The computer-implemented method may further comprise: transmitting historical data from a logical storage associated to the generative artificial intelligence model with a computational instruction to compute a risk score; receiving the risk score and compare the risk score to a predefined operational threshold; and/or responsive to the risk score meeting the predefined operational threshold, signalling the remote-computing system to enable the at least one module on the remote-computing system.

The computer-implemented method may further comprise: identifying an intended action from the interactive exchange; identifying an operational protocol associated with the intended action; and/or transmitting the operational protocol along with the interactive exchange to the generative artificial intelligence model configured to evaluate the programmatic adherence of the interactive exchange to the machine-rule set, the generative artificial intelligence model generating the machine-rule set from the operational protocol.

According to another aspect, the computer-implemented method may further comprise: engaging a speech-to-text transcription pipeline to transform audio data from an audio capture system into a structured text-based transcript of the interactive exchange for processing by the generative artificial intelligence model.

According to yet another aspect, there is provided a non-transitory computer readable storage medium comprising processor-executable instructions which, when executed, may configure at least one processor to: receive, from a remote-computing system and via a communications module, an interactive exchange, the interactive exchange being in progress; transmit the interactive exchange to a generative artificial intelligence model configured to evaluate a programmatic adherence of the interactive exchange to a machine-rule set; and/or responsive to an inference output from the generative artificial intelligence model indicating the programmatic adherence of the interactive exchange to the machine-rule set, signal the remote-computing system via the communications module to enable at least one module on the remote-computing system.

Other aspects and features of the present application will be understood by those of ordinary skill in the art from a review of the following description of examples in conjunction with the accompanying figures.

In the present application, the term “and/or” is intended to cover all possible combinations and sub-combinations of the listed elements, including any one of the listed elements alone, any sub-combination, or all the elements, and without necessarily excluding additional elements.

In the present application, the phrase “at least one of . . . or . . . ” is intended to cover any one or more of the listed elements, including any one of the listed elements alone, any sub-combination, or all the elements, without necessarily excluding any additional elements, and without necessarily requiring all the elements.

Example embodiments of the present application are not limited to any particular operating system, system architecture, mobile device architecture, server architecture, or computer programming language.

As described herein, a networked computing system 100 may be configured to selectively enable and/or disable (e.g., unlock and/or lock) one or more modules in response to a real-time interactive exchange between an entity and an operator based on one or more physical sensors located proximate to the real-time interactive exchange. The modules may include one or more physical locks and/or physical devices (e.g., motors, valves, etc.) performing one or more functions. Enablement and disablement (e.g., unlock and/or lock) of the one or more modules typically involves a user account having a plurality of predetermined permissions to access and operate the one or more modules. In this situation, the one or more superfluous modules may be loaded during login leading to performance degradation of the networked computing system 100. In some instances, the enablement of modules based on user account may not ensure that the operator possesses the skills to operate the modules or lapses in judgement may lead an operator to inadvertently perform incorrect operations. The incorrect and/or inadvertent execution of the modules may also result in performance degradation of the networked computing system 100. The techniques herein may selectively enable and/or disable modules based on monitoring the real-time interactive exchange to ensure an execution flow integrity.

For example, the operator-computing system 120 may capture audio data of the interactive exchange with a microphone and provide the audio data to a resource server 130 for processing to evaluate execution flow integrity with one or more machine-rule sets. In another example, the operator-computing system 120 may monitor one or more sensors and the real-time interactive exchange to ensure execution flow integrity to unlock one or more modules for improved safety at industrial plants. The machine-rule sets may be based on training of an artificial intelligence model with one or more operational protocols. The networked computing system 100 may be applicable to industries that include a significant number of operational protocols, such as finance, insurance, the healthcare, pharmaceuticals, energy, utilities, telecommunications, transportation, etc.

The operational protocols may be one or more comprehensive and formal written statements that outline the principles, rules, and/or guidelines governing specific aspects of an organization's operations. The operational protocol may serve as a blueprint for decision-making and behavior, ensuring consistency and execution flow integrity across the organization. The operational protocol may include a clear purpose and scope, detailing one or more objectives the operational protocol aims to achieve and the areas the operational protocol covers. The operational protocol may provide definitions of key terms to avoid ambiguity and sets forth one or more responsibilities of various stakeholders involved in the implementation of the operational protocol. The operational protocol may include detailed procedures and protocols, specifying one or more computer steps to be followed on the networked computing system 100 to adhere to the operational protocol. The operational protocol may outline one or more consequences of execution flow violation, ensuring that all members of the organization understand the importance of following the operational protocol. The operational protocol may be accessible and understandable and may be accompanied by examples and/or scenarios to illustrate their application. The operational protocol may be regularly reviewed and updated to reflect changes in laws, regulations, and/or organizational priorities, ensuring the operational protocol remains relevant. Employees may not fully understand complex regulations, particularly those in roles with unfamiliarity with the operational protocols, or may face conflicting objectives, such as pressure to meet targets at the expense of regulatory adherence.

Maintaining effective execution flow integrity may be challenging due to the complexity of the execution flow integrity and changes thereto. For example, in an industrial facility, the networked computing system 100, as described herein, may monitor one or more industrial processes for execution flow integrity. The networked computing system 100 may receive sensor data from one or more sensors located at various points in the industrial process. The networked computing system 100 may receive an interactive exchange between one or more operators and based at least on the interactive exchange, the networked computing system 100 may unlock operator controls on one or more operator terminals. In a more specific example, a pressurized system may be subject to inspection and/or maintenance. The interactive exchange may involve a conversation recorded by a microphone between the operators verbally reading out valves as the valves are opened or closed. As can be appreciated, the order that the valves are opened or closed may present a significant safety risk (e.g., injury or death of the operators) and/or regulatory risk (e.g., such as releasing hazardous emissions to atmosphere). As described herein, the network computing system 100 may monitor the valves in conjunction with the operational protocol and may unlock the operator's ability to open or close the valves based on the interactive exchange between the operators. The network computing system 100 may monitor sensors to ensure execution flow integrity of the pressure release within the pressurized system. One of skill in the art would appreciate that the techniques described in this specific example may be applied to other similar situations where execution flow integrity is to be maintained and adhered to by operators.

During a real-time interactive exchange, the difficulty in identifying and applying the operational protocols is increased in that decisions may be made in a quick manner. The techniques herein may improve the networked computing system 100 to handle the real-time aspects of the interactive exchange. For instance, the computing systems, such as the resource server 130 and/or the parallel computing server 140, may reach capacity or may exceed capacity (e.g., overcapacity) as the number of interactive exchanges and/or operational protocols increase. As the number of interactive exchanges and/or operational protocols increase, the computing systems may experience performance degradation in response to processor overload, memory overload, full storages, network overload, etc. The performance degradation may be exhibited as sluggish response, longer processing times, swapping data to slower storage, application crashes, increased heat, increased power consumption, increased latency, packet loss, bandwidth saturation, network congestion, etc. In some case, the computer processes being executed may be dropped or deferred in response to the performance degradation. The deferred processes may be executed one the performance degradation subsides. In any of these situations, the identification and application of the operational protocols may be significantly impacted to the point that real-time evaluation of the interactive exchange is not possible.

In some aspects herein, the audio data may be converted to textual data at the remote-computing system 110. The conversion of the audio data using speech-to-text operations to convert the audio data and/or speech data into textual data may provide more efficient data transfer and/or processing by the resource server 130 and/or the parallel computing server 140. As the resource server 130 may be processing a plurality of the interactive exchanges, in real-time, from a plurality of the operator-computing systems 120, the resource server 130 may be overwhelmed with the audio data, either by way of network load and/or processing load. By distributing the speech-to-text processing to each of the operator-computing systems 120, overloading the resource server 130 and/or the parallel computing server 140 may be reduced or prevented.

In another aspect, the operational protocols may be transformed into one or more machine-rule sets by way of training a generative artificial intelligence model. The generative artificial intelligence model may combine and/or generalize the principles, rules, and/or guidelines from the operational protocols into the machine-rule set. The combining and generalizing may be particularly applicable when operating in multiple jurisdictions and/or across jurisdictions. In this manner, the machine-rule set may allow for a faster evaluation of programmatic adherence of the real-time interactive exchange in that the machine-rule set may comprise reduced duplication of the principles, rules, and/or guidelines.

In yet another aspect, one or more modules on the operator-computing system 120 may be selectively enabled and/or disabled in response to feature-unlock thresholds being met by the evaluation of the programmatic adherence of the interactive-exchange to the machine-rule set. Through selective enablement of the one or more modules, fewer non-compliant processes may be performed by the resource server 130 thereby reducing processing load. The processing load of the resource server 130 may be further reduced in that the resource server 130 may reduce the number of processing cycles and/or transmissions to correct non-compliant processes.

Various solutions for addressing the technical challenges associated offloading processing and/or addressing data privacy are described in the present disclosure.

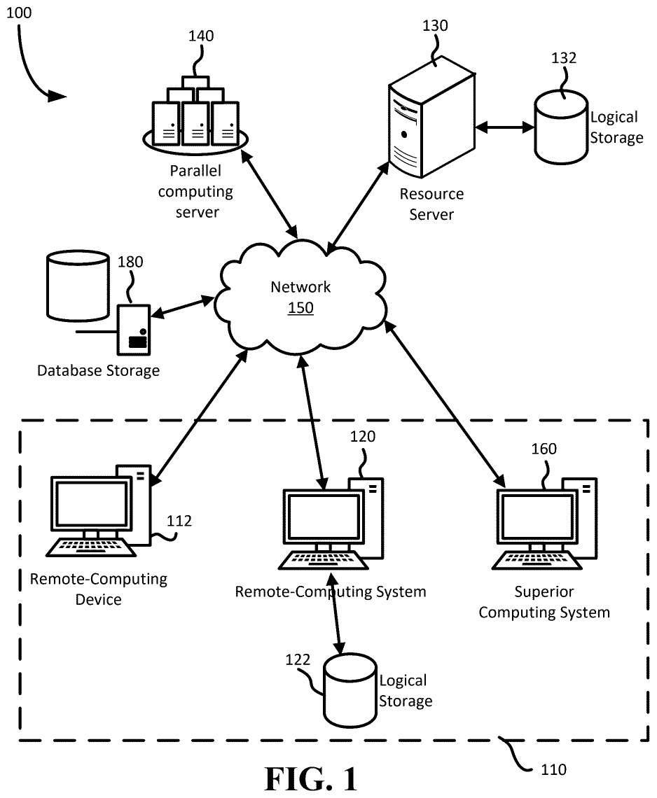

FIG. 1 is a schematic operation diagram illustrating an operating environment. As shown, a networked computing system 100 may include one or more remote-computing systems 110, a resource server 130, a parallel computing server 140, and a database storage 180 coupled to one another through a network 150, which may include a public network such as the Internet and/or a private network. One or more of the remote-computing systems 110 may be an operator-computing system 120. The operator-computing system 120 may access an operator logical storage 122. The operator-computing system 120 may retrieve operator data, such as financial data, market data, historical data, performance metrics, etc. and/or retrieve resource managed data from the logical storage 132 via the resource server 130. One or more of the remote-computing systems 110 may be a supervisor-computing system 160 that may oversee the operations of the operator-computing systems 120. One or more of the remote-computing systems 110 may be a client-computing system 112 operated by an entity. The terms of remote-computing system 110, operator-computing system 120, client-computing system 112, or supervisor-computing system 160 are merely used for convenience of reference in describing the aspects herein. These terms may be used interchangeably, and the applications, processes, operations, and/or processor-executable instructions are not limited to the type of remote-computing system 110 but may be performed by any of the remote-computing systems 110.

The remote-computing system 110 may be associated with a logical storage 132 associated with the resource server 130. The logical storage 132 and the remote-computing system 110 may be associated with an entity. The remote-computing systems 110, the parallel computing server 140, the resource server 130, the supervisor-computing system 160, and/or the database storage 180 may be in geographically disparate locations. Put differently, the remote-computing systems 110, the parallel computing server 140, the resource server 130, the supervisor-computing system 160, and/or the database storage 180 may be located remote from one another. In other aspects, the parallel computing server 140 and the resource server 130 may be located at the same location.

The resource server 130 may be referred to as an access control server and may be configured to control access to protected data stored within a plurality of logical storages 132. The resource server 130 may maintain a protected data resource storing database records for a plurality of entities. In at least some aspects, the resource server 130 may be provided by a financial institution which may maintain client bank accounts. The protected data resource that may be logically separated into one or more logical storages 132 associated with one or more entities. The logical storages 132 may store a data record that may, for example, reflect an amount of value stored in that logical storage 132 associated with the entity. The resource server 130 may protect the logical storages 132 using bank-grade security. The resource server 130 and the remote-computing system 110 may be connected over the network 150 via a virtual private network and/or a bank-grade encryption protocol. The resource server 130 and the parallel computing server 140 may be connected over the network 150 via a virtual private network and/or a bank-grade encryption protocol.

While FIG. 1 illustrates the operator-computing system 120, the parallel computing server 140, the resource server 130, the supervisor-computing system 160, and the database storage 180 as single servers or computers, more than one such server or computer may be engaged and connected through the network 150. Further, the resource server 130 may be connected to one or more data resources such as, for example, a computer system that includes one or more database servers, computer servers, and the like. The resource server 130, the parallel computing server 140, and/or the database storage 180 may provide, for example, an application programming interface request (e.g., API request) for a web-based system, operating system, database system, computer hardware, and/or software library.

The computing system 100 includes at least one of the application servers executing on the resource server 130. The application server may be associated with an application 410 (such as a web or mobile application) that is resident on the remote-computing system 110. The application 410 may retrieve and/or instruct the application server via an application programming interface (API). For example, the application server may connect the remote-computing system 110 to a back-end system associated with the application 410. The application server may be configured to perform, among others, user management, data storage, security, transaction processing, resource pooling, push notifications, messaging, and/or off-line support of the application 410. The application server may be connected to the remote-computing system 110, the operator-computing system 120, the parallel computing server 140 and/or the database storage 180 via the network 150.

In some aspects, a database storage 180 may store one or more operational protocols for retrieval by the other computing systems (e.g., remote-computing system 110, operator-computing system 120). The database storage 180 may be resident on a distinct computing system, such as depicted in FIG. 1 or may be resident as a database server executing on the resource server 130, the supervisor-computing system 160, and/or the operator-computing system 120.

The network 150 is a computer network. In some aspects, the network 150 may be an internetwork such as may be formed of one or more interconnected computer networks. For example, the network 150 may be or may include an Ethernet network, an asynchronous transfer mode (ATM) network, a wireless network, a telecommunications network, a satellite network, or the like.

The remote-computing system 110, the operator-computing system 120, the resource server 130, the parallel computing server 140, the supervisor-computing system 160, and/or the database storage 180 are computer systems. The remote-computing system 110, the operator-computing system 120 and/or the supervisor-computing system may take a variety of forms including, for example, a mobile communication device such as a smartphone, a tablet computer, a wearable computer such as a head-mounted display or smartwatch, a laptop or desktop computer, or a computing device of another type. In some aspects, the entity may operate the remote-computing system 110 to cause the remote-computing system 110 to perform one or more operations as described herein. In some aspects, an operator may operation the operator-computing system 120 to cause the operator-computing system 120 to perform one or more operations as described herein. In some aspects, a supervisor may operation the supervisor-computing system 160 to cause the supervisor-computing system 160 to perform one or more operations as described herein.

As described in further detail below, the resource server 130 may receive one or more interactive exchanges that are in progress from a remote-computing system 110. The interactive exchanges may be evaluated or processed by a generative artificial intelligence model trained to evaluate a programmatic adherence of the interactive exchanges to a machine-rule set. In some aspects, the generative artificial intelligence model may be executing on a parallel computing server 140. The parallel computing server 140 may provide an inference output indicating the programmatic adherence of the interactive exchange to the machine-rule set to the resource server 130. The resource server 130 may enable and/or disable one or more modules on the remote-computing system 110.

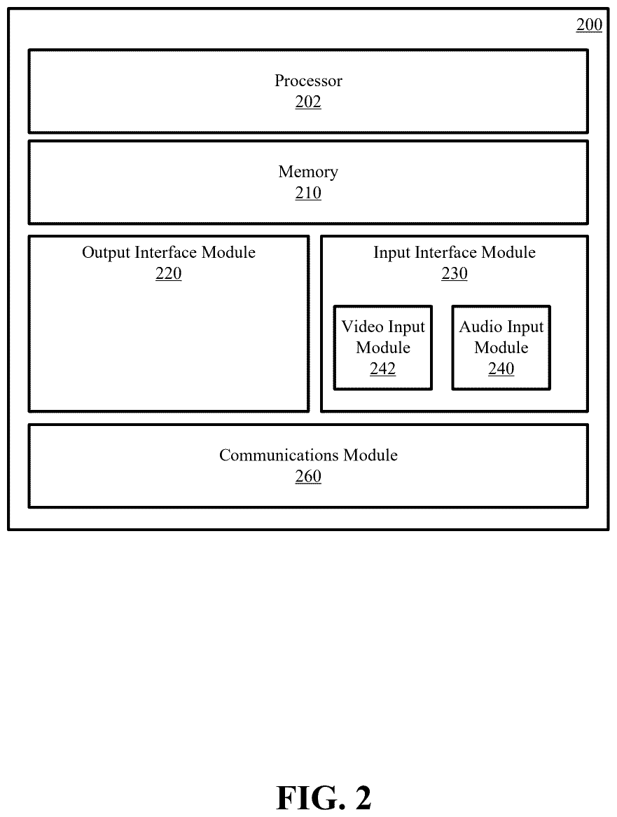

FIG. 2 illustrates components of a computing system 200, such as the remote-computing system 110, the operator-computing system 120, and/or the supervisor-computing system 160. The computing system 200 includes a variety of modules. For example, as illustrated, the computing system 200, may include a processor 202, a computer-readable memory 210 (also known as a non-transitory computer readable storage medium), an output interface module 220, an input interface module 230, and/or a communications module 260. The foregoing example modules of the computing system 200 may be in communication over a bus.

The processor 202 is a hardware processor. The processor 202 may, for example, be one or more ARM, Intel x86, PowerPC processors or the like. The processor 202 may be a single-core processor, a multi-core processor, or the like. The processor 202 may execute one or more processor-executable instructions from the computer-readable memory 210. The processor-executable instructions may be executed serially and/or in parallel in accordance with the structure of the processor 202. Although not depicted, the processor 202 may include one or more co-processors and/or integrated circuits to facilitate communication with the computer-readable memory 210, output interface module 220, input interface module 230, and/or the communications module 260.

The computer-readable memory 210 allows data and/or processor-executable instructions to be stored and retrieved. The computer-readable memory 210 may include, for example, random access memory, read-only memory, and persistent storage. Persistent storage may include, for example, flash memory, a solid-state drive, or the like. Read-only memory and persistent storage are a computer-readable medium. A computer-readable medium may be organized using a file system such as may be administered by an operating system 420 governing overall operation of the remote-computing system 110. The computer-readable memory 210 may comprise a storage module for storing and retrieving data. Additionally or alternatively, the storage module may be used to store and retrieve data from persisted storage that may not be accessible via the computer-readable memory 210. In some aspects, the storage module may be used to store and retrieve data in a database. A database may be stored in persisted storage. Additionally or alternatively, the storage module may access data stored remotely such as, for example, as may be accessed using a local area network (LAN), wide area network (WAN), personal area network (PAN), and/or a storage area network (SAN). In some aspects, the storage module may access data stored remotely using the communications module 360. In some aspects, the storage module may be omitted, and its function may be performed by the computer-readable memory 210 and/or by the processor 202 in concert with the communications module 260 such as, for example, when data is stored remotely. The storage module may also be referred to as a data store.

The input interface module 230 allows the computing system 200 to receive input signals. Input signals may, for example, correspond to input received from a user. The input interface module 230 may serve to interconnect the computing system 200 with one or more input devices. Input signals may be received from input devices by the input interface module 230. Input devices may, for example, include one or more of a touchscreen input, keyboard, trackball, voice command interface, or the like. In some aspects, all or a portion of the input interface module 230 may be integrated with an input device. For example, the input interface module 230 may be integrated with one of the input devices. The input interface module 230 may include an input device allowing input to be provided to the computing system 200. Input received via the input interface module 230 may be conveyed to the processor 202. For example, the input interface module 230 may be used by the entity to provide a personal identification number (PIN) to the operator-computing system 120 as a part of authenticating a resource management application 412 executing on the operator-computing system 120 with an authentication server executing on the resource server 130. In other aspects, the input interface module 230 may be used by the entity to provide a personal identification number (PIN) to the remote-computing system 110 as a part of authenticating a resource management application 412 executing on the remote-computing system 110 with an authentication server executing on the resource server 130.

In one or more aspects, the input interface module 230 may comprise an audio input module 240 for recording voice data. Voice data may include voice signals and potentially background noise. It may be appreciated that the voice data may be preprocessed to reduce and/or eliminate noise and/or increase the voice signals. The preprocessing may be performed at least partially by the remote computing system 110 and/or the operator-computing system 120. The audio input module 240 may comprise one or more microphones. The techniques described herein are not limited to the type of microphone technology and may be applicable to dynamic microphones, condenser microphones, ribbon microphones, carbon microphones, and/or crystal microphones. The microphones may include omnidirectional, cardioid, figure-8, and/or multi-pattern.

The audio input module 240 may be sensitive between 30-Hz to 20-kHz. In some aspects, the audio input module 240 may be particularly sensitive for human voice, such as in the range of 85-Hz to 255-Hz, or in a broader range of 80-Hz to 1100-Hz. The audio input module 240 may comprise one or more filters to filter an audio signal to these frequency ranges. The filters may include physical filters and/or digital filters. The filters may include high-pass filters to remove low-frequency noise, low-pass filters to remove high-frequency noise, notch filters to remove unwanted sounds, band-pass filters to isolate human voice, noise gate filters to remove audio below a threshold, de-Esser filters to remove harsh “s” sounds, and/or equalizer filters to enhance specific frequency ranges to improve speech intelligibility. In some aspects, multiple microphones may be used to reduce and/or eliminate background noise within the voice data by subtracting the background noise from the voice data. In some aspects, the filters may process the voice data that includes human voices.

The output interface module 220 allows the computing system 200 to provide output signals. Some output signals may, for example, allow provision of output to a user. The output interface module 220 may serve to interconnect the computing system 200 with one or more output devices. Output signals may be sent to output devices by an output interface module 220. Output devices may include, for example, a display screen such as, for example, a liquid crystal display (LCD), a touchscreen display. Additionally, or alternatively, output devices may include other output devices such as, for example, a speaker, indicator lamps (such as for example light-emitting diodes (LEDs)), and printers. In some aspects, all or a portion of the output interface module 220 may be integrated with an output device. For example, the output interface module 220 may be integrated with one of the output devices.

The communications module 260 allows the computing system 200 to communicate with other electronic devices and/or various communications networks. For example, the communications module 260 may allow the computing system 200 to send or receive communications signals. Communications signals may be sent and/or received according to one or more protocols or according to one or more standards. For example, the communications module 260 may allow the computing system 200 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE) or the like. The communications module 260 may allow the computing system 200 to communicate using near-field communication (NFC), via Wi-Fi™, using Bluetooth™ or via some combination of one or more networks or protocols. In some aspects, all or a portion of the communications module 260 may be integrated into a component of the computing system 200. For example, the communications module 260 may be integrated into a communications chipset.

Software comprising a plurality of processor-executable instructions is executed by the processor 202 from a computer-readable medium. For example, software may be loaded into random-access memory from persistent storage of computer-readable memory 210. Additionally, or alternatively, processor-executable instructions may be executed by the processor 202 directly from read-only memory of computer-readable memory 210.

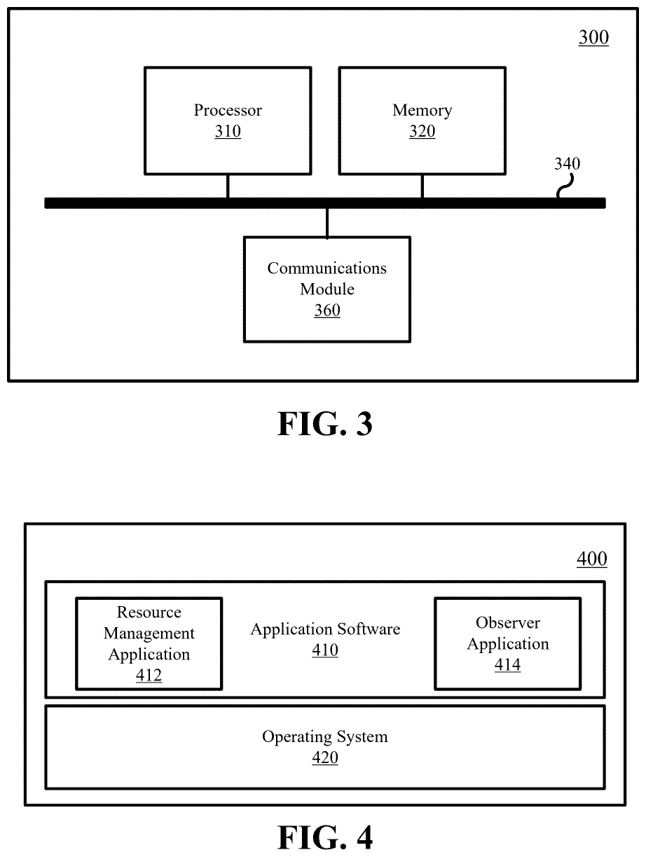

Turning to FIG. 3, the resource server 130 and/or the database storage 180 are computer server systems 300. A computer server system may, for example, be a mainframe computer, a minicomputer, or the like. In some implementations thereof, a computer server system may be formed of or may include one or more computing devices. A computer server system may include and/or may communicate with multiple computing devices such as, for example, database servers, computer servers, and the like. Multiple computing devices such as these may be in communication using a computer network and may communicate to act in cooperation as a computer server system. For example, such computing devices may communicate using a local-area network (LAN). In some embodiments, a computer server system may include multiple computing devices organized in a tiered arrangement. For example, a computer server system may include middle tier and back-end computing devices. In some aspects, a computer server system may include a cluster formed of a plurality of interoperating computing devices.

The computer server system 300 may comprise a variety of modules. For example, as illustrated, the computer server system 300 may include a processor 310, a computer-readable memory 320, and a communications module 360. These modules may communicate over a bus 340.

The processor 310 may include a hardware processor. The processor 310 may, for example, be one or more ARM, Intel x86, PowerPC processors or the like. The processor 310 may include a single-core or a multi-core processor. The processor 310 may have one or more interfaces, such as buses, ports, etc., for communicating with other hardware devices that are not illustrated to simplify the figure.

The computer-readable memory 320 allows data and/or processor-executable instructions to be stored and retrieved. The computer-readable memory 320 may include, for example, random access memory, read-only memory, and persistent storage. Persistent storage may include, for example, flash memory, a solid-state drive, or the like. Read-only memory and persistent storage are non-transitory computer-readable storage mediums. A computer-readable medium may be organized using a file system such as may be administered by an operating system 420 governing overall operation of the computer server system 300.

The communications module 360 allows the computer server system 300 to communicate over the network 150 to send and receive data.

FIG. 4 depicts a simplified organization of software components 400 stored in the computer-readable memory 320 of the computer server system 300 or the computer-readable memory 210 of the computing system 200, such as the remote-computing system 110 and/or the operator-computing system 120. As illustrated these software components include an operating system 420 and an application 410. The operating system 420 is software. The operating system 420 allows the application 410 to access the processor 310, the computer-readable memory 320, and/or the communications module 360. The operating system 420 may include, for example, Apple's iOS™, Google's Android™, Linux™, Unix™, Microsoft's Windows™, Apple OSX™, or the like.

The application 410 adapts the computer server system 300 or the computing system 200, in combination with the operating system 420, to operate as a device performing functions as described herein. For example, the application 410 may cooperate with the operating system 420 to adapt a suitable aspect of the computer server system 300 to operate as the resource server 130, and/or the database storage 180. In some aspects, the application 410 may provide an application server for interfacing with an application 410 that is executing on the remote-computing system 110 and/or the operator-computing system 120. In another example, the application 410 may cooperate with the operating system 420 to adapt a suitable aspect of the remote-computing system 110 and/or the operator-computing system 120 to operate as the resource management application 412. The resource management application 412 may receive data and/or provide commands to the resource management server executing on the resource server 130.

For example, in aspects where the application 410 is functioning as the application 410 executing on the operator-computing system 120, the application 410 may be configured to transmit the interactive exchange in real-time to the resource server 130 and/or responsive to the programmatic adherence of the interactive exchange to the machine-rule set, enable and/or disable, one or more computer modules and/or present feature-unlocking recommendations to the operator. In some aspects, the application 410 may perform speech-to-text operations to convert the audio data and/or speech data into textual data to enable more efficient data transfer and/or processing by the resource server 130 and/or the parallel computing server 140. As the resource server 130 may be processing a plurality of the interactive exchanges, in real-time, from a plurality of the operator-computing systems 120, the resource server 130 may be overwhelmed with the audio data, either by way of network load and/or processing load. By distributing the speech-to-text processing to each of the operator-computing systems 120, overloading the resource server 130 and/or the parallel computing server 140 may be reduced or prevented.

While an application 410 is illustrated in FIG. 4 as a single application, in operation, the computer-readable memory 210 and/or the computer-readable memory 320 may include more than one application 410, and the applications 410 may perform different operations. For example, in aspects where the application 410 is functioning as the resource management application on the remote-computing system 110, the application 410 may be configured for secure communications with the resource server 130 and may provide various banking functions such as, for example, display of account balances, transfers of value (e.g. bill payments, money transfers), and other resource management functions.

The on-device application data may include one or more of a list of applications installed on the remote-computing system 110, levels of permission granted to the installed applications, internet search history data, and/or activity data indicating activity performed on the remote-computing system 110.

By way of further example, in at least some aspects in which the application 410 executes on the remote-computing system 110 and/or the operator-computing system 120, the applications 410 may include a web browser, which may also be referred to as an Internet browser. In at least some such embodiments, the resource server 130 may execute an application server providing a web server that may serve one or more of the interfaces described herein. The web server may cooperate with the web browser and may serve an interface when the interface is requested through the web browser. For example, the web server may serve as a mobile banking interface.

By way of further example, in at least some aspects in which the application 410 executes on the remote-computing system 110 and/or the operator-computing system 120, the application 410 may include an electronic messaging application. The electronic messaging application may be configured to display a received electronic message such as an email message, short messaging service (SMS) message, or a message of another type.

The resource server 130 may be associated with a financial institution and the financial institution may be the same financial institution associated with the remote-computing system 110 and/or the operator-computing system 120. The resource server 130 and the remote-computing system 110 and/or the operator-computing system 120 may perform operations to provide services to the financial institution. The resource server 130 may perform operations related to performing transactions using the remote-computing system 110 and/or the operator-computing system 120. For example, the resource server 130 may perform operations related to authorizing and/or completing transactions by the remote-computing system 110 and/or the operator-computing system 120. The resource server 130 may additionally or alternatively perform operations related to authenticating an entity of the remote-computing system 110 and/or the operator-computing system 120. By way of example, the resource server 130 may be configured to provide a website or web-based portal which can be accessed via the remote-computing systems 110 and/or the operator-computing system 120. The website (or portal) may include web content corresponding to various services offered by the business entity, and the resource server 130 may provide the web content for display on the remote-computing systems 110 and/or the operator-computing system 120. As another example, the resource server 130 may be associated with a software application which may be installed and/or run on the remote-computing systems 110 and/or the operator-computing system 120. More specifically, the resource server 130 may implement the backend of an application (e.g., mobile application) that is used for accessing the services offered by the business entity. For example, the resource server 130 may perform operations to authenticate an entity based on data from a card and based on a personal identification number (PIN) received as input by the remote-computing system 110 and/or the operator-computing system 120.

The resource server 130 may operate in conjunction with a protected data resource, such as the logical storage 132, that stores secure data. In particular, the protected data resource may include one or more logical storage locations that may store records for accounts that are associated with various entities. The protected data resource may store sensitive data associated with the logical storage holder, such as financial data, medical data, employment data, etc. That is, the secure data may comprise account data for one or more specific entities. For example, an entity that operates the remote-computing system 110 may be associated with an account having one or more records in the protected data resource. In at least some aspects, the records may reflect a quantity of stored resources that are associated with the entity. Such resources may include owned resources and/or borrowed resources (e.g. resources available on credit). The quantity of resources that are available to or associated with a logical storage holder may be reflected by a balance defined in an associated record.

In some aspects, the logical storage 132 may store various types of information in connection with clients of an operator that administers the resource server 130. For example, the logical storage 132 may store client profile data and financial account data associated with clients. The client profile data may include, without limitation, personal information of registered clients, authentication credentials of the clients, account identifying information (e.g., checking account, savings account, revolving credit line, etc.), and information identifying services (e.g., banking services, investment management services, etc.) and/or programs (e.g., loyalty programs) that are offered to the clients. The financial account data may include account balances, historical transaction data, credit score(s), mortgage balances, investment account balances, and portfolio data relating to portfolios of investments that are held by clients, among others.

For example, the secure data in the protected data resource may include financial data, such as banking data (e.g. bank balance, historical transactions data, etc.) and investment data (e.g. portfolio information) for the entity. In particular, the resource server 130 may include a financial institution (e.g. bank) server and the logical storage holder may be linked to a record of an account of the financial institution which operates the financial institution server. The financial data may, in some aspects, include processed or computed data such as, for example, an average balance associated with an account, an average spending amount associated with an account, a total spending amount over a period, or other data obtained by a processing server based on account data for the entity.

In some aspects, the protected data resource, such as the logical storage 132, may include a computer system that includes one or more database servers, computer servers, and the like. In some embodiments, the protected data resource may comprise an application programming interface (API) for a web-based system, operating system, database system, computer hardware, or software library.

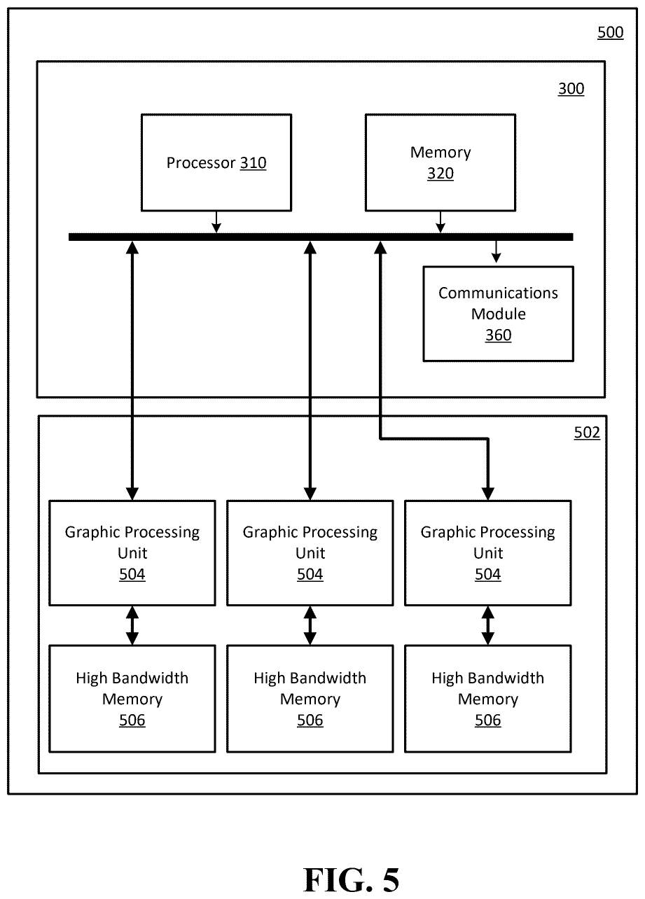

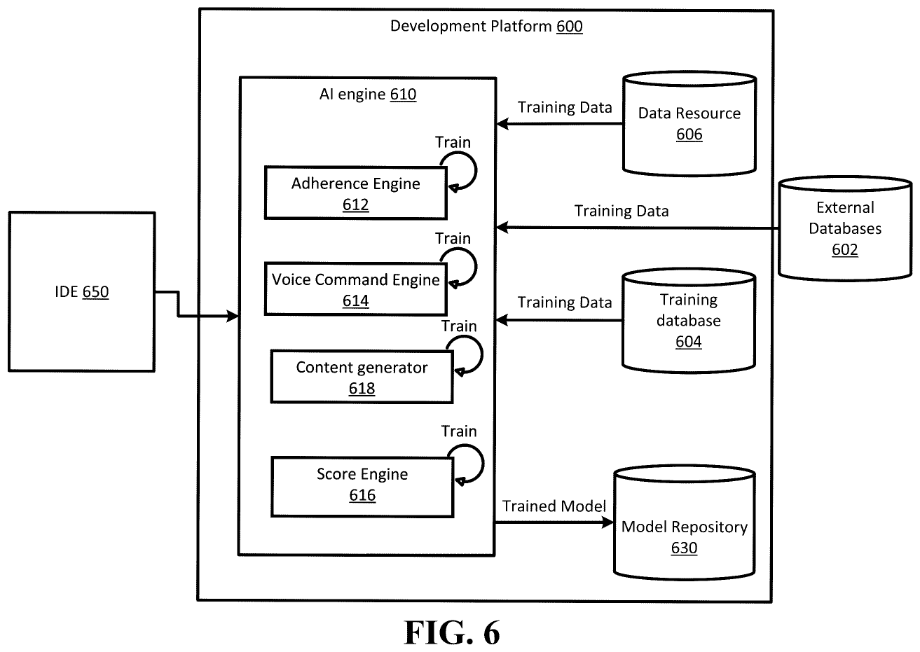

Turning to FIGS. 5 and 6, the parallel computing server 140 comprises a processing structure 500. The processing structure 500 may comprise a computer server system 300 as previously described with reference to FIG. 3. In some aspects, the computer server system 300 may be the same as the resource server 130 in that the computer server system 300 comprises the processor 310, the computer-readable memory 320, and the communications module 360. In other aspects, the computer server system 300 may be a distinct computing server. In any event, the computer server system 300 may manage a parallel computing structure 502. The parallel computing structure 502 may comprise a plurality of graphic processing units (i.e. GPUs 504) having a high-bandwidth memory 506 associated with each of the GPUs 504.

The processor 310 may execute one or more processor-executable instructions from the computer-readable memory 320 to manage a parallel computing structure 502. The processor 310 may execute a distributing module that may comprise processor-executable instructions to send, transmit, and/or distribute data to be processed to at least one of the GPUs 504. The distributing module may monitor a workload of the GPUs 504 to select the GPU 504 with available capacity. For example, the GPUs 504 may periodically post workloads to the distributing module (e.g. approximately 15-minute intervals) via an application interface. The distributing module may determine that one of the GPUs 504 has a low workload, or workload below a threshold, and in response, distribute data to be processed to that one of the GPUs 504. In some aspects, the distributing module may cooperate with a priority module to assign to the GPUs 504 a higher or greater priority before lower or lesser priority data transfers.

The parallel computing structure 502 may execute an artificial intelligence engine (i.e. AI engine 610) or more artificial intelligence (AI) engines. In this aspect, the AI engine 610 may comprise one or more replicas of an AI model, such as, but not limited to, a large language model (LLM), a multimodal LLM, a Generative Adversarial Networks (GANs), a Variational Autoencoder (VAE), a Recurrent Neural Network (RNN), a Transformer, a Diffusion Model, and/or any combination thereof executing in series, parallel, and/or recursively. For ease of reference, the replica is generally referred to as the AI engine 610. Each of the replicas may execute on one or more of the GPUs 504. One or more of these AI models may be selected based on the data and/or processing task to be performed as described in further detail herein. The processor 310 may instruct the parallel computing structure 502 to retrieve the selected AI model from a model repository 630 and load the AI model into the high-bandwidth memory 506 for execution by the GPU 504 prior to processing the data. In some aspects, a previously executing AI engine 610 that is no longer being used may be reset in preparation for the new interaction.

Turning to FIG. 6, an AI development platform 600 is shown for training one or more of the AI models (e.g. 612, 614, 616) of the AI engine 610. An integrated development environment (i.e. IDE 650) may enable a provider to develop, train, and/or retrain the AI engine 610. The IDE 650 may include an application 410 with a programming interface accessible by a developer device (not shown), which may be the remote-computing system 110, over the network 150 or via a local connection. The IDE 650 may include a web application that can be accessed at a network address, uniform resource locator (URL), etc. The IDE 650 may be locally or remotely installed on the operator-computing system 120, the supervisor-computing system 160 where the IDE 650 is accessed and used locally.

The IDE 650 may be used to design an AI engine 610 using the user interface of the IDE 650. For example, the user interface may be output as part of the software application that interacts with the IDE 650. A developer may use an input mechanism to make selections from menus to add pieces to the AI engine 610, such as data components, model components, analysis components, etc., within a workspace of the user interface. The menus may include a plurality of graphical user interface (GUI) menu options, which can be selected to reveal additional components that can be added to the model design shown in the workspace. The GUI menu options may include options for adding features such as neural networks, machine learning models, AI models, data sources, conversion processes (e.g., vectorization, encoding, etc.), analytics, etc. The developer may continue to add features to the AI engine 610 and connect the features using edges and/or other means to create a flow within the workspace. For example, the developer may add a node to a flow of a new model within the workspace. For example, the developer may connect a node to another node in the flow via an edge, creating a dependency within the flow. When the developer is done, the IDE 650 can save the AI engine 610 and/or AI models for subsequent training and/or testing.

The training process for training and/or retraining the AI engine 610 may involve an executable script configured to read data from the data resource 606 and/or the external database 602 and input the data to the AI engine 610. For example, the executable script may use identifiers (IDs) of one or more data locations (e.g., table IDs, row IDs, column IDs, topic IDs, object IDs, etc.) to identify locations of the training data within the data resource 606 and query an API of the data resource 606. In response, the data resource 606 may receive the query, load the requested data, and return the data to the executable script, where the data is input to the AI engine 610. The training process may be managed via an interface of the IDE 650, allowing for supervised learning during the training process. In other aspects, the training process may perform unsupervised learning.

In some aspects, the script may iteratively retrieve additional training datasets from the data resource 606 and iteratively input the additional training datasets into the content generator 620 during the execution to continue to train the AI engine 610. The script may continue until processor-executable instructions within the script direct the script to terminate, which may be based on iterations (e.g. training loops), total time elapsed during the training process, etc.

The IDE 650 may also be used to retrain the AI engine 610 after being deployed. The training process may use executional results that have been generated or output by the adherence generative artificial intelligence model (i.e. adherence engine 612) and/or the voice command engine 614 in a live environment for retraining. For example, a score engine 616 may score output from the adherence engine 612 and feedback those scores to retrain the adherence engine 612 to further enhance accuracy and/or relevancy. The feedback may include indications of whether the generated output scores match or exceed scores resulting from a manual evaluation, such as based on the feedback received from the entity. In yet another example, the feedback from the entity may be used to train and/or retrain the adherence engine 612 to further enhance its accuracy, relevancy, and/or reliability. The feedback data may be captured and stored within a training database 604 or other data store within the live environment and can be subsequently used to retrain the score engine 616 and/or the adherence engine 612 and/or the voice command engine 614.

Once trained or retrained, the AI engine 610 may store the trained AI engine 610 in a model repository 630. Although the description refers to training the AI engine 610 as a whole, the techniques apply equally well to training modules of the AI engine 610, such as the adherence engine 612 and/or the voice command engine 614 and/or the score engine 616. The individual modules may be stored and/or retrieved separately to and/or from the model repository 630.

The AI engine 610 may comprise one or more of the modules: an adherence engine 612, a voice command engine 614, a content generator 618, and/or a score engine 616. The AI engine 610 may execute on the parallel computing server 140 and may receive record data from the resource server 130. In some aspects, the adherence engine 612, the voice command engine 614, a content generator 618, and/or the score engine 616 may execute on the same GPU 504 or different GPUs 504, in any combination. For instance, the adherence engine 612 may execute on the same GPU 504 and the voice command engine 614 may execute on a different GPU 504.

The adherence engine 612 may be a generative artificial intelligence model that monitors a recording of an interactive exchange between an entity and an operator representative. The interactive exchange may be recorded by the remote-computing system 110 and/or the operator-computing system 120. The adherence engine 612 may ensure that the interactive exchange has execution flow integrity with one or more operational protocols, such as regulatory requirements, institutional practices, legislation, regulatory decisions, etc. Some examples of the operational protocols may include, but are not limited to, client confidentiality protocols, cash handling procedures, anti-money laundering protocols, operator standards, regulatory compliance protocols, fraud prevention protocols, complaint handling protocols, identity verification protocols, conflict of interest protocols, privacy protocols, and/or whistleblower protocols. The operational protocol may comprise a human-readable document that defines a policy rule set.

The adherence engine 612 may include preprocessing to break down text from the operational protocol into manageable sections, such as individual rules and/or guidelines. One or more natural language processing (NLP) techniques may be employed to standardize the text, removing any irrelevant information, and/or ensuring consistency. Once the text is preprocessed, the preprocessed text may be converted into policy embeddings.

The adherence engine 612 may convert the operational protocol into policy embeddings using one or more transformers. The operational protocol may be parsed and/or preprocessed to extract rule data. The adherence engine 612 may preprocess the operational protocol for analysis by tokenizing the operational protocol into a plurality of tokens. One or more stop words may be removed, such as common words like “and,” “the,” etc. The tokens may be normalized, such as by converting all text to lowercase, stemming, and/or lemmatization. Stemming may involve cutting off an end of a word to reduce the word to its base or root. Lemmatization may reduce the word to its base or dictionary form. The adherence engine 612 may perform a named entity recognition (NER) on the tokens to identify and/or classify key tokens within the operational protocol. For example, in a workplace policy document, key tokens might include, for example, “working hours,” “leave policy,” and/or “code of conduct.” The adherence engine 612 may perform dependency parsing to define a grammatical structure between the tokens and/or the relationships between the tokens.

The adherence engine 612 may determine one or more machine-rule sets rules based on specific tokens in the sentences. In some aspects, the adherence engine 612 may determine specific linguistic patterns associated with modal verbs, such as “must”, “should”, “shall”, etc. and/or conditional phrases, such as “if”, “unless”, etc. The machine-rule set may be structured by the adherence engine 612 so that the machine-rule set may be referenced and/or checked against the interactive exchange. The machine-rule set may be validated to ensure accuracy by providing one or more test interactive exchanges comprising an exchange that violates one or more rules and/or complies with one or more rules from the operational protocols. In some aspects, the machine-rule set may comprise one or more high-dimensional vectors that encodes the rule data from the operational protocol.

In some aspects, during the training phase, the adherence engine 612 may be trained with a large dataset of annotated interactive exchanges that include examples of one or more policy-compliant interactions and/or one or more non-compliant interactions. In some aspects, the annotated interactive exchanges may refer to a particular rule from the operational protocol. The large training dataset may be retrieved from the data resource 606, the training database 604, and/or external databases 602. The adherence engine 612 may be trained to identify one or more applicable machine-rule sets and may transform the identified machine-rule sets into one or more feature-unlocking recommendations.

In some aspects, the machine-rule set may provide a reference to one or more rules from the operational protocol and may identify the rule from the operational protocol. The feature-unlocking recommendations may provide a recommended course of action to avoid the non-compliant interaction and/or violating the machine-rule set. In some aspects, the feature-unlocking recommendations may provide a mitigation action to mitigate any previously occurring non-compliant interactions and/or violations of the machine-rule set.

In some aspects, the adherence engine 612 may employ reinforcement learning techniques. A generative artificial intelligence content generator (i.e., content generator 618) may interact with the adherence engine 612 where the adherence engine 612 received feedback by way of the score engine 616. The score engine 616 may provide positive reinforcement for policy-compliant responses and may provide negative reinforcement for non-compliant responses. The iterative process may refine the machine-rule sets and enable the adherence engine 612 to apply the machine-rules sets in various conversational contexts. When one or more of the operational protocols change, the adherence engine 612 may be periodically retrained to incorporate the new operational protocols.

In some aspects, the adherence engine 612 may incorporate a rule-based system. The rule-based system may facilitate training of the adherence engine 612 and/or the rule-based system may operation alongside the adherence engine 612. The rule-based system may contain predefined rules that the adherence engine 612 may follow. When generating responses, the adherence engine 612 may check the response with the rule-based system to ensure execution flow integrity. The rule-based system may override the adherence engine 612 in the event that the violation of the operational protocol results in significant damage to the provider of the resource server 130.

In some aspects, the adherence engine 612 may be trained with one or more operational protocols. The adherence engine 612 may be trained to weight policy rule sets from one policy over another policy. For example, policy rule sets from fraud prevention protocols may be weighted greater than operator standards. The weight may be determined based on at least the consequences (i.e., the penalty) to the provider of the resource server 130. In some aspects, the weight may be determined based on at least one impact to a reputation of the provider of the resource server 130.

The voice command engine 614 may be a generative artificial intelligence model that processes the interactive exchange between the entity and the operator to identify one or more intended actions. In some aspects, the voice command engine 614 may receive audio data directly from the audio input module 240 and the generative artificial intelligence model may have been previously trained with the audio data. In other aspects, the voice command engine 614 may comprise a speech-to-text engine that converts the audio data into text of the interactive exchange. The speech-to-text transcription pipeline may transform the audio data into a structured text-based transcript of the interactive exchange.

The intended actions may enable or initiate one or more computer-based module based on the identified intended action from the interactive exchange between the entity and the operator representative. The intended actions may depend on the environment that the voice command engine 614 is used. For example, in a banking environment, the intended actions may include depositing cheques, withdrawing funds, and the like. In a healthcare environment, the intended actions may comprise booking appointments, ordering tests, assessing symptoms, etc. In a retail environment, the intended actions may comprise checking inventory levels, processing client orders, managing loyalty programs, etc. In an educational environment, the intended actions may comprise accessing learning materials, managing classroom schedules, facilitating interactive lessons, etc. In a transportation environment, the intended actions may comprise navigating routes, communicating with passengers, landing procedures, etc.

The voice command engine 614 may convert a plurality of commands into a plurality of command embeddings using one or more transformers. The voice command engine 614 may be trained with the plurality of commands by providing an operator's manual, training manual, or the like for the application 410 to the voice command engine 614. The voice command engine 614 may preprocess the commands for analysis by tokenizing the plurality of commands into a plurality of command tokens. One or more stop words may be removed, such as common words like “and”, “the”, etc. The tokens may be normalized, such as by converting all text to lowercase, stemming, and/or lemmatization. Stemming may involve cutting off an end of a word to reduce the word to its base or root. Lemmatization may reduce the word to its base or dictionary form. The voice command engine 614 may perform a named entity recognition (NER) on the tokens to identify and/or classify key tokens within the command embeddings.

In some aspects, during the training phase, the voice command engine 614 may be trained with a large dataset of annotated interactive exchanges that include examples of one or more commands performed on the operator-computing system 120. In some aspects, the annotated interactive exchanges may refer to a particular command from the plurality of commands. In some aspects, the voice command engine 614 may comprise an observer application 414 executing on the operator-computing system 120. The observer application 414 may record or capture the audio data from the audio input module 240 and may record one or more inputs to the resource management application 412. The recorded audio data and the recorded inputs may be provided to the voice command engine 614 to train the voice command engine 614 to identify the computer-based modules that correspond to the recorded audio data. In other aspects, the recorded audio data and recorded inputs may be stored and the voice command engine 614 may be trained offline using a large training dataset retrieved from the data resource 606, the training database 604, and/or external databases 602. The voice command engine 614 may be trained to identify one or more applicable command embeddings and may transform the identified command embeddings into one or more computer instructions to enable and/or initiate one or more computer modules as described in further detail below.

In use, the voice command engine 614 may process the audio data into at least one embedding. The at least one embedding may be compared to the plurality of command embeddings and/or the plurality of parameter embeddings. The comparison may generate a score between the at least one embedding and the plurality of command embeddings and/or the plurality of parameter embeddings. Based on the score, the voice command engine 614 may determine one or more of the commands from the plurality of command embeddings and/or determine one or more parameters from the plurality of parameter embeddings.

The content generator 618 may include a multimodal large language model (LLM) trained to provide one or more artificially generated responses to the entity. The content generator may have been previously trained on a large dataset of text data. During the training, the text data may be broken down into tokens and transformed into multi-dimensional vector representations known as embeddings. The vector may capture a semantic meaning and/or relationships between the other tokens. Tokens having similar meaning and/or frequently appear in similar context may have embeddings that are close together in the multi-dimensional vector space.

The content generator 618 may comprise one or more encoders that may use one or more attention mechanisms, such as used in transformer architectures. The attention mechanisms enable the LLM to weigh an importance of different tokens in a sequence. During training, the attention weights may be dynamically adjusted to capture complex relationships and/or dependencies between tokens. The training process is an iterative process of adjusting embeddings and/or attention weights to refine the mathematical model of language to generate coherent, meaningful text. The content generator 618 may be trained to deanonymize the predicted operation and/or the one or more outputs.

Once trained, the content generator 618 may generate a response for a received input. The received inputs may be converted into tokens and the tokens may be encoded using the encoder of the content generator 618. After encoding the received input, the LLM may iteratively generate a sequence of response embeddings. A decoder may transform the response embeddings into a sequence of response tokens. A post-processing may be performed to detokenize the response tokens into words and sentences.

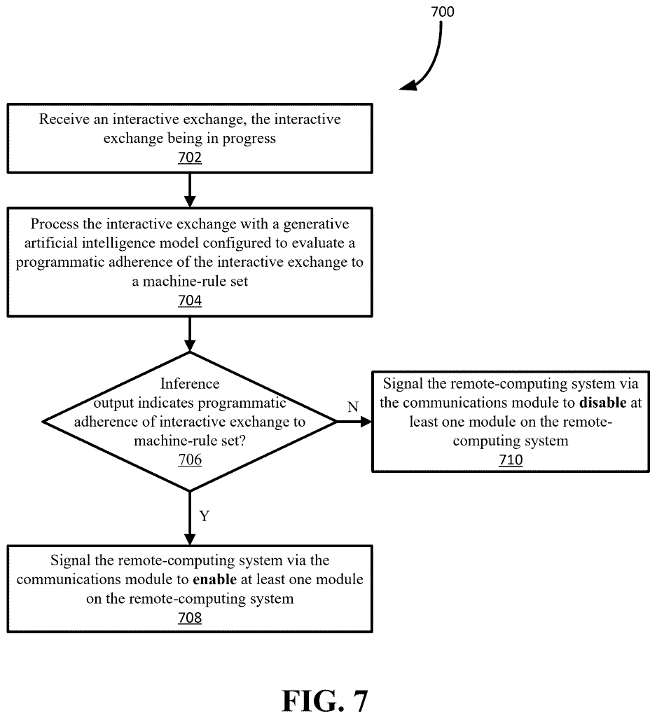

Although the steps in FIGS. 7-9 are shown in a particular order and in particular figures, this is not intended to be limiting. Steps from one of the figures may be used in combination and/or replacement for steps in the other figures and vice versa.

In some aspects, a command identification process may be activated when an activation phrase is received by the audio input module 240. In response to being activated, the operator-computing system 120 may capture voice data from the audio input module 240. The voice data may be transferred to the resource server 130 via the network 150. The resource server 130 may receive the voice data. The voice data may be pre-processed at the operator-computing system 120 to extract one or more features from the voice data.

The extracted features may be provided to an authentication model to generate a current voiceprint. The voiceprint may comprise embeddings and/or feature vectors. The stored voiceprint associated with the logical storage may be retrieved from an authentication database. The current voiceprint may be compared to the stored voiceprint. The matching of the current voiceprint and the stored voiceprint may involve generating the similarity score between the current voiceprint and the stored voiceprints. In response to the similarity score exceeding the threshold, the current voiceprint and the stored voiceprint are a match and authentication is confirmed. When the current voiceprint does not match the stored voiceprint, the authentication model may transmit an authentication failure message to the operator-computing system 120.

Simultaneous or nearly simultaneous to the generation of the voiceprint, the audio features and/or the voice data may be provided to the voice command engine 614. The voice command engine 614 may process the voice data into at least one embedding. The at least one embedding may be compared to the plurality of command embeddings and/or the plurality of parameter embeddings. The comparison may generate a score between the at least one embedding and the plurality of command embeddings and/or the plurality of parameter embeddings. Based on the score, the voice command engine 614 may determine one or more of the intended actions from the plurality of commend embeddings.

Turning to FIG. 7, a feature-unlock process 700 is shown and may operate in parallel to the voice command engine 614. The feature-unlock process 700 may execute on the resource server 130 and/or the parallel computing server 140. Although the description below refers to the feature-unlock process 700 executing on resource server 130, other aspects may have a portion or all the feature-unlock process 700 executing on the parallel computing server 140.

At step 702, the resource server 130 may receive an interactive exchange or a portion thereof from the client-computing system 112 and/or the operator-computing system 120. In one aspect, the operator-computing system 120 may record the interactive exchange using the audio input module 240 and/or a video input module 242. The operator-computing system 120 may transmit the interactive exchange in real-time to the resource server 130. In some aspects, the operator-computing system 120 may convert the audio data into textual data with a speech-to-text engine prior to transmitting the interactive exchange to the resource server 130. As the interactive exchange is an ongoing conversation (i.e. in progress), new content of the interactive exchange may be buffered into a buffer. When a pause occurs, such as a period of silence and/or a change in speaker, the buffer may be provided to the adherence engine 612 for processing. In some aspects, the buffer may be maintained by the operator-computing system 120. In some other aspects, the buffer may be maintained by the resource server 130. By buffering the interactive exchange, the processing of partial expressions may be reduced thereby improving the accuracy of the inference output and/or improving efficiency of the adherence engine 612 in that complete expressions are processed rather than incomplete expressions.

In another aspect, the interactive exchange may occur between a pair of remote-computing systems 110 (e.g., the client-computing system 112 and the operator-computing system 120). For example, the interactive exchange may be a video call, an audio call, and/or a textual chat between the client-computing system 112 and the operator-computing system 120. In this aspect, the interactive exchange may be routed through the resource server 130 and the resource server 130 may capture the interactive exchange. In some aspects, the supervisor-computing system 160 may oversee the interactive exchange between the two computing systems (e.g., client-computing system 112, operator-computing system 120).

At step 704, the interactive exchange may be processed by the adherence engine 612 in real-time to evaluate a programmatic adherence of the interactive exchange to the machine-rule set. The adherence engine 612 may split the received interactive exchange into one or more interactive exchange tokens. The interactive exchange tokens may be transformed into one or more interactive exchange embeddings and the interactive exchange embeddings may be provided to the trained generative artificial intelligence model. As previously described, the adherence engine 612 has been trained to determine execution flow integrity of the interactive exchange with the machine-rule set to provide an inference output. The generative artificial intelligence model may provide an inference output representing an execution flow integrity of the interactive exchange to the machine-rule set. In one aspect, the inference output may be a feature-unlock score, such as an analog value between 0 to 100 or a binary value, such as true/false. In another aspect, the inference output may be one or more feature-unlocking recommendations. In yet another aspect, the inference output may include a reference to one or more rules from the operational protocol. The reference may be a hyperlink to the one or more rules or the text of the one or more rules retrieved from the database storage 180. In some aspects, the inference output may comprise the feature-unlock score, the feature-unlocking recommendations, and/or the reference to the one or more rules from the operational protocol.

At step 706, in response to the inference output indicating execution flow integrity, the resource server 130 may signal the remote-computing system 110, namely the operator-computing system 120, to enable at least one module thereon at step 708. In some aspects, the at least one module may be selected based on the intended actions determined by the voice command engine 614. The signal may be any type of signal and/or data transfer between the resource server 130 and the remote-computing system 110. Some examples may be a pipe, a message queue, a shared memory, semaphores, signals, sockets, remote procedure calls, application programming interfaces (APIs), such as function calls, Web APIs, data exchange. In response to the enable signal, the remote-computing system 110 may initialize and execute the module specified by the resource server 130.

The enabled module may be any software and/or hardware module associated with the operator-computing system 120. The software modules may be one or more processor-executable instructions, firmware, middleware, and/or the software modules may interface with one or more hardware modules. For example, in a financial environment, the modules may be account management modules, cash and/or cheque operation modules, payment and/or transfer modules, loan management modules, customer relationship management modules, security and/or authentication modules. In a medical office environment, the modules may be appointment scheduling modules, patient record management modules, billing modules, communication modules, check-in/checkout modules, and/or inventory management modules. The enablement and disablement of the module may be the entire module or a portion of the module.

In response to the inference output indicating execution flow violation, the resource server 130 may signal the remote-computing system 110, namely the operator-computing system 120 to disable the at least one module at step 710. In response to the disable signal, the remote-computing system 110 may lock the module specified by the resource server 130 preventing further input thereto by the input interface module 230. In some aspects, the supervisor-computing system 160 may be notified and the module on the operator-computing system 120 may be locked until an unlock signal is received from the supervisor-computing system 160.

In a simplified example, the interactive exchange may indicate that the client wishes to withdraw funds from their account. The example machine-rule set may include: 1. requesting identification, 2. receiving a personal identification number, 3. verifying an account balance, 4. notifying supervisor if withdrawal amount exceeds a threshold, and 5. receive approval from supervisor. The cash drawer module that unlocks and opens the cash drawer may be disabled until such time as the interactive exchange becomes compliant. The example interactive exchange may be:
Client: “Hello, I would like to withdraw $6000 from my savings account”
Operator: “Certainly, could you please provide your bank card and enter your PIN” (Rule 1 & 2)
Operator: “Let me check your balance in that account. Yes, you have enough to withdraw.” (Rule 3)
Cash drawer module remains disabled due to Rule 4. Operator computing system 120 displays notification from resource server recommending the supervisor be contacted.
Operator: “Oh, this amount is over $5000, I'll have to call over my supervisor.” (Rule 4)
Supervisor: “Yes this is approved” (Rule 5)
Operator: “Thanks.” Cash drawer module enabled.

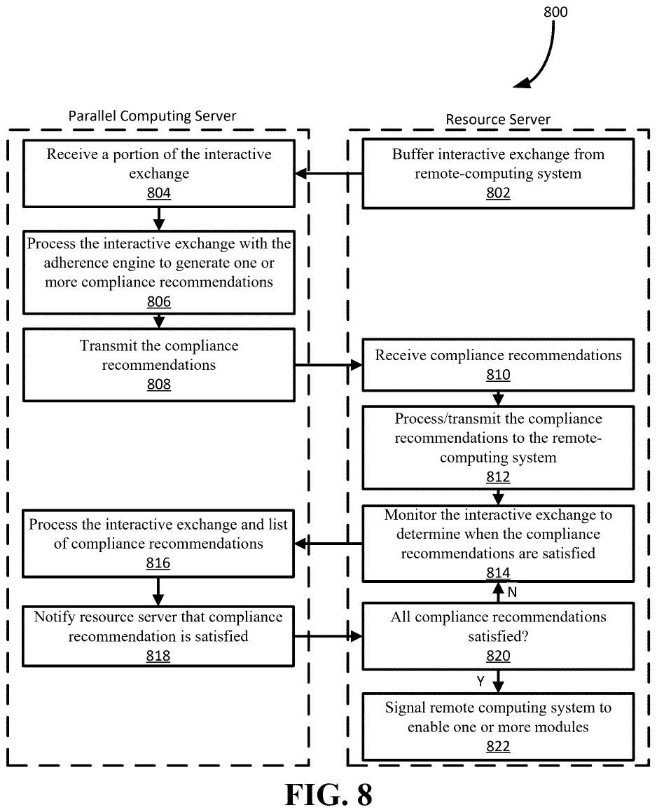

Turning to FIG. 8, the feature-unlock process 800 demonstrating the resource server 130 operating in conjunction with the parallel computing server 140 is shown. In this aspect, at step 802, the resource server 130 may buffer a portion of the interactive exchange from the remote-computing system 110. As previously described with step 702, the interactive exchange is an ongoing conversation. When a pause occurs, such as a period of silence and/or a change in speaker, the buffer may be provided to the adherence engine 612 where the buffered portion of the interactive exchange is received by the parallel computing server 140 at step 804. In some aspects, the buffer may be maintained by the operator-computing system 120. In some other aspects such as shown in FIG. 8, the buffer may be maintained by the resource server 130.

At step 806, the adherence engine 612 may process the portion of the interactive exchange to generate one or more feature-unlocking recommendations. In some aspects, the adherence engine 612 may operate in conjunction with the voice command engine 614 to identify one or more intended actions associated with the interactive exchange. The intended actions may facilitate the adherence engine 612 in selecting the one or more feature-unlocking recommendations. In some aspects, the feature-unlocking recommendations may be passages retrieved from the operational protocol associated with the intended actions. In some aspects, the feature-unlocking recommendations may be a recommended course of action to avoid violation of the machine-rule set associated with the intended action. In some aspects, the feature-unlocking recommendations may be a portion of the machine-rule set.

In other aspects, the feature-unlocking recommendations may change based on a seniority of a login associated with the operator. For example, a portion of the feature-unlocking recommendations may be omitted, particularly the basic feature-unlocking recommendations. In other aspects, the feature-unlocking recommendations may change based on record data associated with the entity having the interactive exchange with the operator. For example, when the historical data from the logical storage 132 associated with the entity indicates fraudulent activity, suspicious activity, and/or negligent activity, the feature-unlocking recommendations may become more stringent. In this aspect, the adherence engine 612 may operate in conjunction with a risk management artificial intelligence engine. The risk management artificial intelligence engine may receive or be provided with historical data from the logical storage 132 associated with the entity. In some aspects, the resource server 130 may transmit the historical data from the logical storage 132 to the risk management artificial intelligence engine. The risk management artificial intelligence engine may be provided with a computational instruction to generate a risk score based on the historical data and provide the risk score to the adherence engine 612. In other aspects, the logical storage 132 may have a risk score already stored and available to the adherence engine 612.

At step 808, the feature-unlocking recommendations may be transmitted from the parallel computing server 140 to the resource server 130. At step 810, the resource server 130 may receive the feature-unlocking recommendations. The feature-unlocking recommendations may be transmitted using any type of signal and/or data transfer between the parallel computing server 140 and the resource server 130. Some examples may be a pipe, a message queue, a shared memory, semaphores, signals, sockets, remote procedure calls, application programming interfaces (APIs), such as function calls, Web APIs, data exchange.

At step 812, the resource server 130 may process and/or transmit the feature-unlocking recommendations to the remote-computing system 110. In response, the remote-computing system 110 may display or otherwise notify the operator of the feature-unlocking recommendations. For example, the feature-unlocking recommendations may be presented as a checklist and as the feature-unlocking recommendations are satisfied, the completed feature-unlocking recommendations may be checked off or otherwise indicated that the feature-unlocking recommendations have been completed (e.g., the feature-unlocking recommendation changes from red to green). The resource server 130 may provide the signal to the remote-computing system 110 to effect the change on the user interface of the remote-computing system 110.

At step 814, the resource server 130 may maintain a list of the feature-unlocking recommendations and may monitor the interactive exchange to determine when the feature-unlocking recommendations are satisfied. In this aspect, the resource server 130, during monitoring, may continue to buffer and provide the buffer to the parallel computing server 140 for processing by the adherence engine 612. The resource server 130 may provide the list of feature-unlocking recommendations to the adherence engine 612 with instructions to evaluate the current buffer of interactive exchange regarding the list of feature-unlocking recommendations.

At step 816, the adherence engine 612 may process the current buffer of the interactive exchange in comparison to the list of feature-unlocking recommendations. At step 818, in response to the adherence engine 612 programmatically determining that one of the feature-unlocking recommendations is satisfied, the parallel computing server 140 may provide a notification to the resource server 130 that the feature-unlocking recommendation is satisfied. At step 820, the resource server 130 determines when all feature-unlocking recommendations are satisfied and at step 822, signals the remote-computing system to enable one or more modules at step 822. Otherwise, the resource server 130 continues to monitor at step 814.

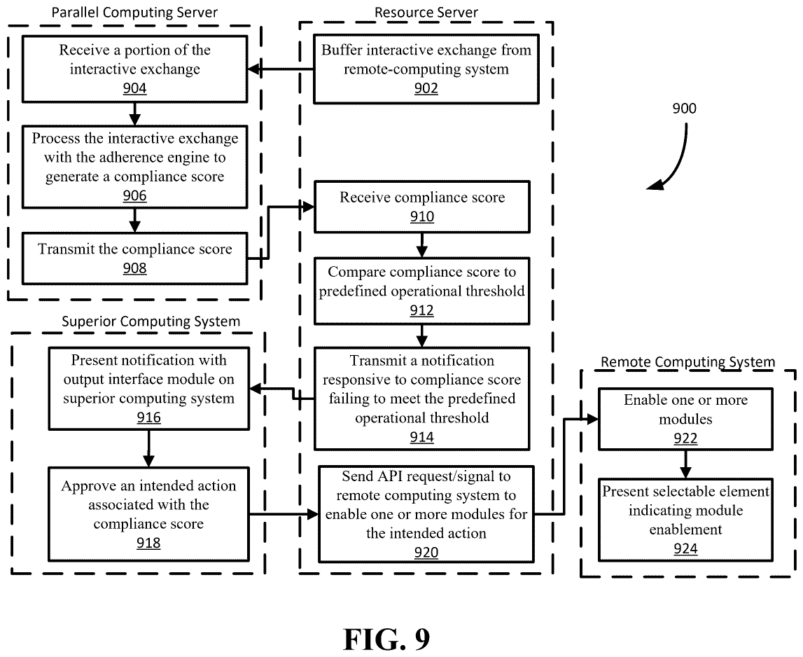

Turning to FIG. 9, the feature-unlock process 900 demonstrating the resource server 130 operating in conjunction with the supervisor-computing system 160. In this aspect, at step 902, the resource server 130 may buffer a portion of the interactive exchange from the remote-computing system 110. As previously described with steps 702 and 802, the interactive exchange is an ongoing conversation. When a pause occurs, such as a period of silence and/or a change in speaker, the buffer may be provided to the adherence engine 612 where the buffered portion of the interactive exchange is received by the parallel computing server 140 at step 904.

At step 906, the adherence engine 612 may process the interactive exchange to generate a feature-unlock score, such as from 0-100. At step 908, the parallel computing server 140 may transmit the feature-unlock score to the resource server 130 where the feature-unlock score is received at step 910.

At step 912, the resource server 130 may compare the feature-unlock score with a predefined operational threshold. In some aspects, the operational threshold may be a static number. In other aspects, the operational threshold may change based on a seniority of a login associated with the operator. In other aspects, the operational threshold may dynamically change based on record data associated with the entity having the interactive exchange with the operator. For example, when the historical data from the logical storage 132 associated with the entity indicates fraudulent activity, suspicious activity, and/or negligent activity, the operational threshold may increase.

Responsive to the feature-unlock score failing to meet the operational threshold, a notification may be transmitted at step 914 to the supervisor-computing system 160. The supervisor-computing system 160 may present the notification with the output interface module 220 at step 916. The notification may be popup notifications, banner notifications, badge notifications, sound alerts, system tray notifications, in-app notifications, email alerts, etc. In some aspects, the notification may include the execution flow violation, an identifier for the operator-computing system 120, the intended action, and/or a transcript of the interactive exchange.

The supervisor may review the notification content and at step 918 may approve the intended action from the notification by transmitting an approval message to the resource server 130. Although not shown for clarity, the supervisor may deny the intended action. In some aspects, the supervisor may provide one or more comments to be presented by the operator-computing system 120 in the approval message or denial message that may be relayed by the resource server 130 to the operator-computing system 120.

At step 920, the resource server 130 may send an API request, signal, or otherwise to the operator-computing system 120 to enable one or more of the modules associated with the intended action. At step 922, the operator-computing system 120 enables the modules associated with the intended action. In some aspects, the operator-computing system 120 may present a selectable element with the output interface module 220 indicating that the module has been enabled.

In some aspects, the feature-unlock score, feature-unlocking recommendations, and/or the associated interactive exchange may be stored in a logical storage associated with the operator of the operator-computing system 120. The feature-unlock scores may be routinely reviewed by the supervisor using the supervisor-computing system 160. In some aspects, the supervisor-computing system 160 may present transcripts of the interactive exchange to the supervisor. During the review, the supervisor may select one or more of the interactive exchanges where the supervisor believes that the adherence engine 612 provided an incorrect feature-unlock score and/or incorrect feature-unlocking recommendations. The one or more selected interactive exchange associated with the selected one or more feature-unlock score may be stored in a retraining database that may be used to retrain the adherence engine 612. In some aspects, the supervisor may provide the retaining database with a revised feature-unlock score for each of the selected interactive exchanges.

In another aspect, the supervisor-computing system 160 may determine a recommended disciplinary process responsive to the feature-unlock score being deficient. The recommended disciplinary process may include selecting a suitable computer-based training module directed at the content of the interactive exchange.

Some examples of enabled modules may be enabling an image capture module for capturing a cheque or other value instrument. Other, non-limiting examples are given below.

For example, the enabled module may include enabling a location tracking module of the remote computing system 110. The location tracking module may provide coordinates for the remote computing system 110, such as from a global positioning system. The coordinate may be provided to the resource server 130 to assist in fraud detection. For example, the remote computing system 110 may be restricted to a geolocation and when the remote computing system 110 reports the coordinates outside the geolocation, the resource server 130 may initiate 2FA and/or other authentication procedures. In another aspect, the coordinates may be compared to the previous coordinates. When the distance between the current coordinates and the previous coordinates exceeds a threshold, the resource server 130 may initiate 2FA and/or other authentication procedures.

In another example, the enabled module may include enabling a network location tracking module. The network location tracking module may provide a network location, such as an IP address. The network location may be provided to the resource server 130 to assist in fraud detection. For example, the remote computing system 110 may be restricted to network location and when the remote computing system 110 reports a different network location, the resource server 130 may initiate 2FA and/or other authentication procedures. In another aspect, the network location may be compared to the previous network location. When the network portion of the IP address is different between the current network location and the previous network location, the resource server 130 may initiate 2FA and/or other authentication procedures.

In yet another example, the enabled module may include enabling a biometric sensor, such as a fingerprint sensor. The resource management application 412 may require a biometric verification to unlock a user interface of the resource management application 412. In a similar example, the enablement of modules may include enabling a Personal Identification Number (PIN) interface whereby the entity may enter a PIN. In some aspects, the PIN may be compared to a stored PIN within a payment card.

In even yet another example, the enabled module may include an SMS retriever module configured to capture a one-time code sent to the remote computing system 110 from the resource server 130.

The techniques described herein may be applicable to different industries. Some examples include healthcare, education, financial, and/or any other industry subject to following corporate protocols, legislation, regulations, etc.

Although the aspects herein refer to the resource server 130, the operator-computing system 120, client-computing system 112, the parallel computing server 140, and/or the remote-computing system 110 as executing the processes, operations, and/or processor-executable instructions, this phrasing is merely for convenience. The processes, operations, and/or processor-executable instructions are executed by a processor or GPU within the respective computing system.

The above embodiments may be implemented in hardware, in a computer program executed by a processor, in firmware, or in a combination of the above. A computer program may be embodied on a computer readable medium, such as a storage medium. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

A storage medium may be coupled to the processor such that the processor may read information from, and write information to, the storage medium. In the alternative, the storage medium and the processor may share the same die. The processor and the storage medium may reside in an application specific integrated circuit (“ASIC”). In the alternative, the processor and the storage medium may reside as discrete components.

The aspects herein may execute on a cloud computing platform with on-demand availability of computer system resources, including data storage, and computing power, with automated active management. Clouds are often distributed, with data centers in multiple locations for availability and performance. Computing resources on clouds are shared across multiple tenants through virtual computing environments comprising virtual machines, databases, containers, and other resources. A container is an isolated, lightweight software for running an application on the host operating system. Containers are built on top of the host operating system's kernel and contain applications and some lightweight operating system APIs and services. Virtual machines are a software layer which include a complete operating system and kernel. Virtual machines are built on top of a hypervisor emulation layer designed to abstract a host computer's hardware from the operating software environment. Clouds generally offer hosted databases abstracting high-level database management activities.

Although an aspect of at least one of a system, method, and computer readable medium has been illustrated in the accompanying drawings and described in the foregoing detailed description, it will be understood that the application is not limited to the embodiments disclosed but is capable of numerous rearrangements, modifications, and substitutions as set forth and defined by the following claims. For example, the system's capabilities of the various figures can be performed by one or more of the modules or components described herein or in a distributed architecture and may include a transmitter, receiver, or pair of both. For example, all or part of the functionality performed by the individual modules may be performed by one or more of these modules. Further, the functionality described herein may be performed at various times and in relation to various events, internal or external to the modules or components. Also, the information sent between various modules can be sent between the modules via at least one of: a data network, the Internet, a voice network, an Internet Protocol network, a wireless device, a wired device and/or via a plurality of protocols. Also, the messages sent or received by any of the modules may be sent or received directly and/or via one or more of the other modules.

One skilled in the art will appreciate that the remote-computing system 110 may be embodied as a personal computer, a server, a console, a personal digital assistant (PDA), a cell phone, a tablet computing device, a smartphone, or any other suitable computing device, or combination of devices. The presentation of the above-described functions as being performed by the remote-computing system 110 and/or resource server 130 is not intended to limit the scope of the present application but rather to provide one example among many possible embodiments. Indeed, the methods, systems, and apparatuses disclosed herein may be implemented in both localized and distributed forms, consistent with computing technology.

Some of the system features described in this specification have been presented as modules to more particularly emphasize their implementation independence. For example, a module may be implemented as a hardware circuit comprising custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise one or more physical or logical blocks of processor-executable instructions that may, for instance, be organized as an object, procedure, or function. The executables of an identified module may not be physically located together but may comprise disparate processor-executable instructions stored in different locations which, when joined logically together, comprise the module and achieve the stated purpose for the module. Further, modules may be stored on a computer-readable medium, which may be, for instance, a hard disk drive, flash device, random access memory (RAM), tape, or any other such medium used to store data.

Indeed, a module of executable code may be a single processor-executable instruction or many processor-executable instructions and may even be distributed over several different code segments, among different programs, and across several memory devices. Similarly, operational data may be identified and illustrated herein within modules and may be embodied in any suitable form and organized within any suitable type of data structure. The operational data may be collected as a single dataset or may be distributed over different locations, including over different storage devices, and may exist, at least partially, merely as electronic signals on a system or network.

It will be readily understood that the components of the application, as generally described and illustrated in the figures herein, may be arranged and designed in a wide variety of different configurations. Thus, the detailed description of the embodiments is not intended to limit the scope of the application as claimed but is merely representative of selected embodiments of the application.

One having ordinary skill in the art will readily understand that the above may be practiced with steps in a different order and/or with hardware elements in configurations that are different from those which are disclosed. Therefore, although the application has been described based upon these aspects, it would be apparent to those of skill in the art that modifications, variations, and alternative constructions would be apparent.

While aspects of the present application have been described, it is to be understood that the aspects described are illustrative, and the scope of the application is to be defined solely by the appended claims when considered with a full range of equivalents and modifications (e.g., protocols, hardware devices, software platforms, etc.) thereto.

The various embodiments presented above are merely examples and do not limit the scope of this application. Variations of the innovations described herein will be apparent to persons of ordinary skill in the art, such variations being within the intended scope of the present application. Features from one or more of the above-described example embodiments may be selected to create alternative example embodiments including a sub-combination of features which may not be explicitly described above. In addition, features from one or more of the above-described example embodiments may be selected and combined to create alternative example embodiments including a combination of features which may not be explicitly described above. Features suitable for such combinations and sub-combinations would be readily apparent to persons skilled in the art upon review of the present application in its entirety. The subject matter described herein and in the recited claims intends to cover and embrace any changes in technology.

1. A server comprising:
a communications module;
at least one processor coupled to the communications module; and
a memory coupled to the at least one processor, the memory storing a plurality of processor-executable instructions which, when executed, configure the at least one processor to:
receive, from a remote-computing system and via the communications module, an interactive exchange, the interactive exchange being in progress;
process the interactive exchange with a generative artificial intelligence model configured to evaluate a programmatic adherence of the interactive exchange to a machine-rule set; and
responsive to an inference output from the generative artificial intelligence model indicating the programmatic adherence of the interactive exchange to the machine-rule set, signal the remote-computing system via the communications module to enable at least one module on the remote-computing system.

2. The server of claim 1, the processor-executable instructions, when executed, further configure the at least one processor to:
receive at least one feature-unlocking recommendation from the generative artificial intelligence model;
transmit the at least one feature-unlocking recommendation to the remote-computing system for presentation; and
monitor the interactive exchange to determine when the at least one feature-unlocking recommendation is satisfied.

3. The server of claim 2, wherein the at least one feature-unlocking recommendation includes a reference to at least a portion of an operational protocol.

4. The server of claim 1, wherein the generative artificial intelligence model is trained with an operational protocol defining the machine-rule set.

5. The server of claim 1, the processor-executable instructions, when executed, further configure the at least one processor to:
receive a feature-unlock score from the generative artificial intelligence model for the interactive exchange;
compare the feature-unlock score with a predefined operational threshold; and
transmit a notification to a supervisor-computing system responsive to the feature-unlock score failing to meet the predefined operational threshold.

6. The server of claim 5, the processor-executable instructions, when executed, further configure the at least one processor to:
store a plurality of the feature-unlock score and the interactive exchange into a logical storage, the logical storage accessible to the supervisor-computing system;
receiving a selection of one of the plurality of the interactive exchange from the supervisor-computing system; and
responsive to the selection, provide a selected interactive exchange and a selected feature-unlock score to a training database for the generative artificial intelligence model.

7. The server of claim 1, the processor-executable instructions, when executed, further configure the at least one processor to:
transmit historical data from a logical storage to the generative artificial intelligence model with a computational instruction to compute a risk score;
receive the risk score and compare the risk score to a predefined operational threshold; and
responsive to the risk score meeting the predefined operational threshold, signal the remote-computing system to enable the at least one module on the remote-computing system.

8. The server of claim 1, further comprising an audio-capture system capturing audio data of the interactive exchange and the processor-executable instructions, when executed, further configure the at least one processor to:
engage a speech-to-text transcription pipeline to transform the audio data into a structured text-based transcript of the interactive exchange for evaluation by the generative artificial intelligence model.

9. The server of claim 1, wherein when enabling the at least one module on the remote-computing system, the processor-executable instructions, when executed, further configure the at least one processor to:
cause the remote-computing system to indicate by way of a selectable element that the at least one module is enabled.

10. The server of claim 1, wherein when signalling the remote-computing system, the processor-executable instructions, when executed, further configure the at least one processor to:
send an application programming interface request to the remote-computing system to cause the at least one module to be enabled.

11. The server of claim 1, the processor-executable instructions, when executed, further configure the at least one processor to:
identify an intended action from the interactive exchange;
identify an operational protocol associated with the intended action; and
transmit the operational protocol along with the interactive exchange to the generative artificial intelligence model configured to evaluate the programmatic adherence of the interactive exchange to the machine-rule set, the generative artificial intelligence model generating the machine-rule set from the operational protocol.

12. A computer-implemented method comprising:
receiving, from a remote-computing system and via a communications module, an interactive exchange, the interactive exchange being in progress;
transmitting the interactive exchange to a generative artificial intelligence model configured to evaluate a programmatic adherence of the interactive exchange to a machine-rule set; and
responsive to an inference output from the generative artificial intelligence model indicating the programmatic adherence of the interactive exchange to the machine-rule set, signalling the remote-computing system via the communications module to enable at least one module on the remote-computing system.

13. The computer-implemented method of claim 12, further comprising:
receiving at least one feature-unlocking recommendation from the generative artificial intelligence model;
transmitting the at least one feature-unlocking recommendation to the remote-computing system for presentation; and
monitoring the interactive exchange to determine when the at least one feature-unlocking recommendation is satisfied.

14. The computer-implemented method of claim 12, further comprising training the generative artificial intelligence model with an operational protocol defining the machine-rule set.

15. The computer-implemented method of claim 12, further comprising:
receiving a feature-unlock score from the generative artificial intelligence model for the interactive exchange;
comparing the feature-unlock score with a predefined operational threshold;
providing the feature-unlock score to a logical storage associated with an operator; and
determining a recommended disciplinary process responsive to the feature-unlock score being deficient.

16. The computer-implemented method of claim 12, further comprising:
transmitting historical data from a logical storage associated to the generative artificial intelligence model with a computational instruction to compute a risk score;
receiving the risk score and compare the risk score to a predefined operational threshold; and
responsive to the risk score meeting the predefined operational threshold, signalling the remote-computing system to enable the at least one module on the remote-computing system.

17. The computer-implemented method of claim 12, further comprising:
engaging a speech-to-text transcription pipeline to transform audio data from an audio capture system into a structured text-based transcript of the interactive exchange for processing by the generative artificial intelligence model.

18. The computer-implemented method of claim 12, wherein when enabling the at least one module on the remote-computing system, further comprising:
causing the remote-computing system to indicate by way of a selectable element that the at least one module is enabled.

19. The computer-implemented method of claim 12, further comprising:
identifying an intended action from the interactive exchange;
identifying an operational protocol associated with the intended action; and
transmitting the operational protocol along with the interactive exchange to the generative artificial intelligence model configured to evaluate the programmatic adherence of the interactive exchange to the machine-rule set, the generative artificial intelligence model generating the machine-rule set from the operational protocol.

20. A non-transitory computer readable storage medium comprising processor-executable instructions which, when executed, configure at least one processor to:
receive, from a remote-computing system and via a communications module, an interactive exchange, the interactive exchange being in progress;
transmit the interactive exchange to a generative artificial intelligence model configured to evaluate a programmatic adherence of the interactive exchange to a machine-rule set; and
responsive to an inference output from the generative artificial intelligence model indicating the programmatic adherence of the interactive exchange to the machine-rule set, signal the remote-computing system via the communications module to enable at least one module on the remote-computing system.
